(19) United States
(12) Patent Application Publication
(10) Pub. No.: US 2003/0214600 A1
(43) Pub. Date: Nov. 20, 2003

(54) Digital camera

(75) Inventor: Toshihito Kido, Matsubara-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/439,854

(22) Filed: May 16, 2003

(30) Foreign Application Priority Data
May 17, 2002 (JP) P2002-143020

(51) Int. Cl. H04N 5/235

(52) U.S. Cl. 348/362

(57) ABSTRACT

The digital camera has an image synthesizing function of synthesizing a plurality of images. As synthesizing methods in the image synthesizing function (image synthesis modes), an “addition synthesis mode” of simply adding a plurality of images and an “averaging synthesis mode” of averaging a plurality of images are prepared. The “addition synthesis mode” is suitable for a relatively dark subject and the “averaging synthesis mode” is suitable for a relatively light subject. In the case of activating the image synthesizing function, any of the image synthesis modes is selected by the user. After an image capturing instruction is given by depression of a shutter start button, the selected image synthesis mode is checked and a synthesizing process according to the image synthesis mode is performed. Consequently, by selecting the image synthesis mode in accordance with a subject, a composite image adapted to the subject can be generated.

This application is based on application No. 2002-143020 filed in Japan, the contents of which are hereby incorporated by reference.

### BACKGROUND OF THE INVENTION

1. Field of the Invention

The present invention relates to a technique of synthesizing a plurality of images in a digital camera.

2. Description of the Background Art

Hitherto, a plurality of images captured by a digital camera are synthesized by a personal computer to generate a composite image.

In the case of generating a composite image by a personal computer, however, complicated operation is required. Consequently, the user has to know operation of the personal computer very well, and a composite image cannot be easily generated.

In order to deal with such a problem, a digital camera which automatically generates a composite image at the time of photographing has been proposed. When a composite image is generated only by a predetermined single synthesizing method, however, a digital camera cannot handle various states of subjects such as a bright subject, a subject which moves fast, and the like. An effect of imaging adapted to a subject in a composite image cannot be produced.

### SUMMARY OF THE INVENTION

The present invention is directed to a digital camera having an image capturing device for obtaining an image of a subject.

According to one aspect of the present invention, the digital camera includes: a synthesis mode selector for selecting one image synthesis mode from a plurality of image synthesis modes in which different synthesizing methods each for synthesizing a plurality of images are set; an instruction reception part for receiving an image capturing instruction for allowing the image capturing device to start capturing images, from a user; and a synthesizing part for generating a composite image by synthesizing a plurality of images obtained by the image capturing device by using one of the different synthesizing methods in the image synthesis modes selected, in response to the image capturing instruction.

A synthesizing method used for synthesizing a plurality of images can be selected from the plurality of image synthesis modes. Hence, by selecting an image synthesis mode in accordance with a subject, an effect suitable for each subject can be produced in a composite image obtained as a result. Since a composite image is generated in response to an image capturing instruction, the composite image can be generated easily without accompanying a complicated operation.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing main components of a digital camera as a preferred embodiment of the present invention;

FIG. 2 is a top view showing main components of the digital camera;

FIG. 3 is a rear view showing main components of the digital camera;

FIG. 4 is a diagram showing an example of a screen for making a setting of whether an image synthesizing function is activated or not;

FIG. 5 is a diagram showing an example of a screen for selecting an image synthetic mode;

FIG. 6 is a diagram showing main internal components of the digital camera as functional blocks;

FIG. 7 is a diagram showing the flow of operations of the digital camera when a setting of activating the image synthesizing function is made;

FIG. 8 is a diagram showing an example of a screen for inquiring whether an end instruction is given or not;

FIG. 9 is a diagram showing the detailed flow of an addition synthesis mode process;

FIG. 10 is a diagram showing an example of a program chart which is referred to in the addition synthesis mode;

FIG. 11 is a diagram for describing a process of generating a composite image in the addition synthesis mode;

FIG. 12 is a diagram showing the detailed flow of an averaging synthesis mode process;

FIGS. 13 to 15 are diagrams showing an example of a program chart which is referred to in the averaging synthesis mode;

FIG. 16 is a diagram for describing a process of generating a composite image in the averaging synthesis mode;

FIG. 17 is a diagram showing the flow of an image synthesis mode selecting process in a second preferred embodiment;

FIG. 18 is a diagram showing the flow of the image synthesis mode selecting process in a third preferred embodiment;

FIG. 19 is a diagram showing a part related to the image synthesizing function in a scene control table;

FIG. 20 is a diagram showing a part of the flow of operation of a digital camera in a fifth preferred embodiment;

FIG. 21 is a diagram showing the detailed flow of a synthesis ratio designation mode process;

FIG. 22 is a diagram showing an example of a screen for receiving a synthesis ratio; and

FIGS. 23 and 24 are diagrams showing an example of a program chart which is referred to in an averaging synthesis mode.

### DESCRIPTION OF THE PREFERRED EMBODIMENTS

Hereinafter, preferred embodiments of the present invention will be described with respect to the drawings.

1. First Preferred Embodiment

1-1. Configuration of Digital Camera

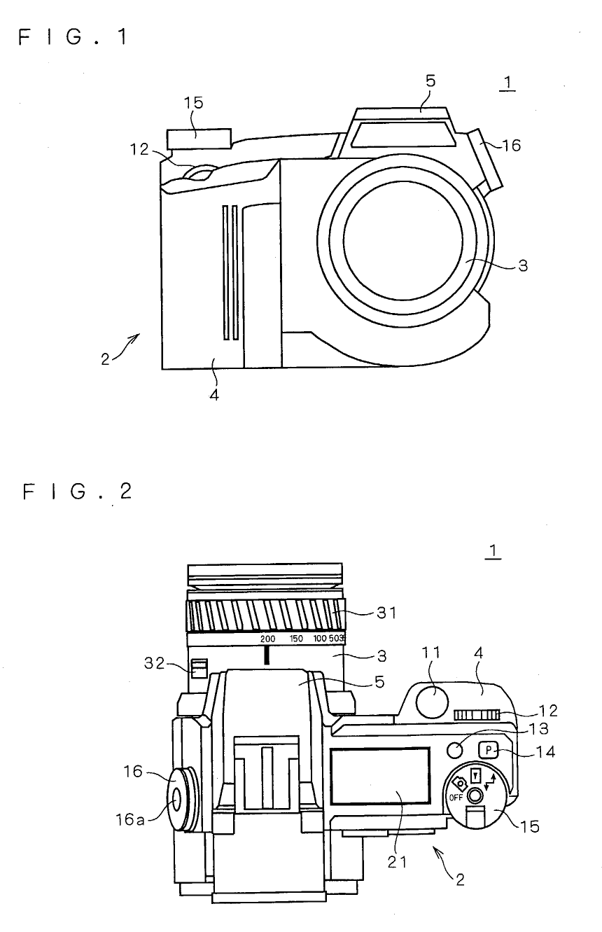

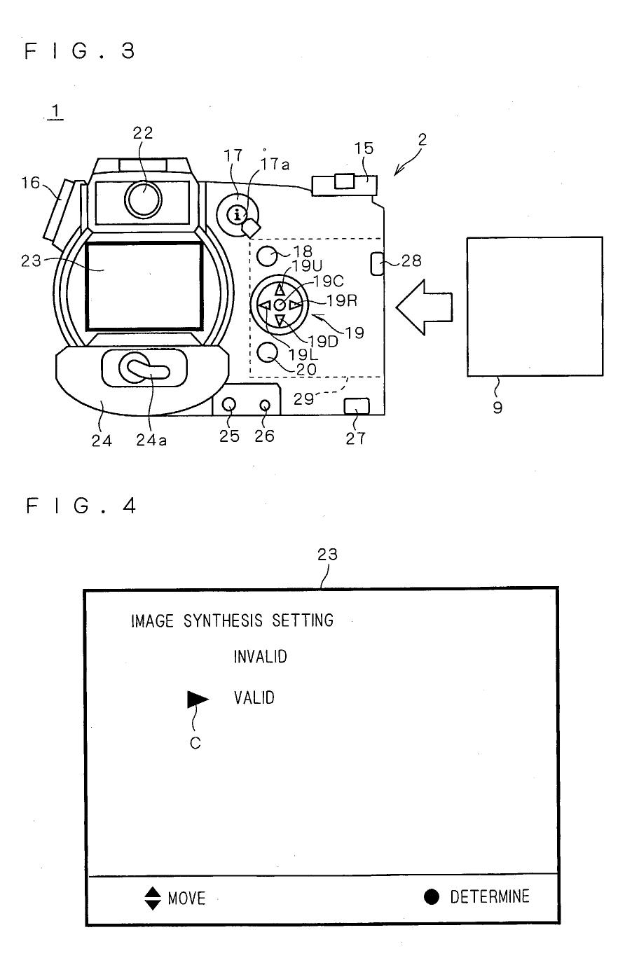

FIGS. 1 to 3 are front view, top view, and rear view, respectively, showing main components of a digital camera 1 according to the preferred embodiment of the present invention. As shown in FIGS. 1 and 2, the digital camera 1 is constructed mainly by a camera body 2 and a taking lens 3.

The taking lens 3 is constructed as a zoom lens including a plurality of lens units. By turning a zoom ring 31 provided at the periphery of the taking lens 3, the magnification (focal length) of the taking lens 3 can be changed. The taking lens 3 has a macro switching lever 32. By sliding the macro switching lever 32, macro image capturing is enabled.

As shown in FIG. 1, in the front face of the camera body 2, a grip portion 4 is provided in the left end portion and a built-in flash 5 is provided in a right upper portion. As shown in FIG. 2, in the top face of the grip portion 4, a shutter start button 11 for receiving an image capturing instruction for starting capturing image data for recording from the user is provided.

In a right portion of the top face of the camera body 2, a dial-type main switch 15 for switching the on/off state of the power supply and switching the operation mode of the digital camera 1 among “image capturing mode”, “reproduction mode”, and “communication mode” is provided.

The “image capturing mode” is an operation mode for photographing a subject to capture image data (hereinafter, simply referred to as “image”) and recording the image into a memory card 9 as a recording medium. The “reproduction mode” is an operation mode of reading the image recorded in the memory card 9 (hereinafter, referred to as “recorded image”) and reproducing and displaying the image. The “communication mode” is an operation mode of performing communications by, for example, transferring a recorded image to an external computer via a USB terminal 27 provided on the rear face of the camera body 2.

A scene selection button 13 for selecting a scene is disposed near the main switch 15. The digital camera 1 has a “scene selector” function of performing an image capturing control which is optimum to each scene. By selecting a desired scene from “portrait”, “scenery”, “sports”, “night view”, and the like with the scene selection button 13, the image capturing control which is preset to the selected scene is performed.

In an upper portion of a side face of the digital camera 1, a function dial 16 and a function button 16a for setting items of the image capturing control regarding capture of an image such as “image size”, “drive mode”, and “exposure mode” are provided. After setting an item by the function dial 16, by turning a selection dial 12 in an upper portion of the grip portion 4 while depressing the function button 16a, a setting of the set item can be selected.

For example, in the item of “drive mode”, a setting can be selected between a “single photographing” operation of capturing an image of one frame in response to a single image capturing instruction and a “continuous photographing” operation for obtaining a plurality of images which are sequential in time while the shutter start button 11 is depressed as a single image capturing instruction.

In the item of “exposure mode”, a setting can be selected from “program mode (P mode)” in which both an f-number and shutter speed are determined by the digital camera 1 in accordance with brightness of the subject, “aperture priority mode (A mode)” in which shutter speed is determined by the digital camera 1 with a priority to an f-number determined by the user, “shutter speed priority mode (S mode)” in which an f-number is determined by the digital camera 1 with a priority to shutter speed determined by the user, and “manual mode (M mode)” in which both an f-number and shutter speed are determined by the user.

By depressing a program set button 14 disposed on the right side of the scene selection button 13, the settings selected as described above are reset to default settings. Concretely, when the program set button 14 is depressed, “standard” in which a scene is not selected in the “scene selector” function, “single photographing” is set as the “drive mode”, and “P mode” is set as the “exposure mode”.

On the left side of the main switch 15 on the top face of the digital camera 1, a data panel 21 for displaying settings of the digital camera 1 for a desired scene, “drive mode”, and “exposure mode” is provided. The display part of the data panel 21 is provided with a back light and is constructed by a monochromatic liquid crystal of a segment type display of high visibility for displaying predetermined signs, numerical values, and the like, so that the settings in the digital camera 1 can be easily grasped.

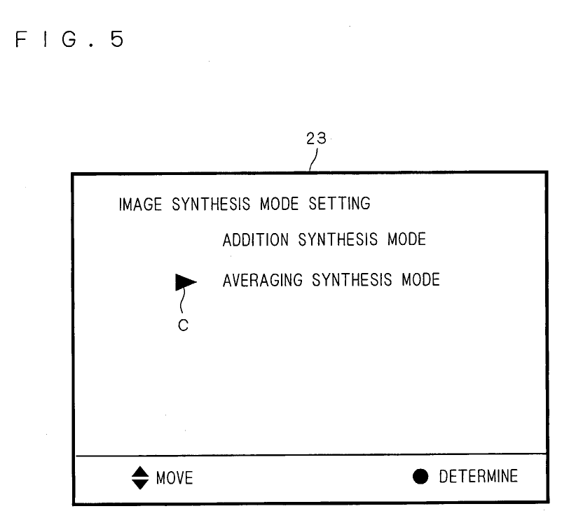

As shown in FIG. 3, a liquid crystal display (hereinafter, referred to as “LCD”) 23 and an electronic view finder (hereinafter, referred to as “EVF”) 22 for displaying a live view of the subject images, reproduced recorded images, and setting menus for making various settings are provided. The display on the LCD 23 and that on the EVF 22 are switched by operating a display switching lever 17 provided on the right side of the EVF 22. To save power, either the LCD 23 or EVF 22 is set in a display state. In the following, description will be made on assumption that the LCD 23 is in the display state. Also in the case where the EVF 22 is in the display state, an image is displayed similarly.

On the right side of the LCD 23, a menu button 18 and a cross key 19 are provided. The cross key 19 is constructed by an up switch 19U, a down switch 19D, a left switch 19L, a right switch 19R, and an execution button 19C in the center portion. When the menu button 18 is depressed, a setting menu is displayed on the LCD 23. Various settings of the digital camera 1 can be made by operating the cross key 19 with reference to the setting menu.

The digital camera 1 has an image synthesizing function of generating a composite image by obtaining a plurality of images and synthesizing the images in response to an image capturing instruction given by the shutter start button 11. Whether the image synthesizing function is activated or not can be set in the setting menu.

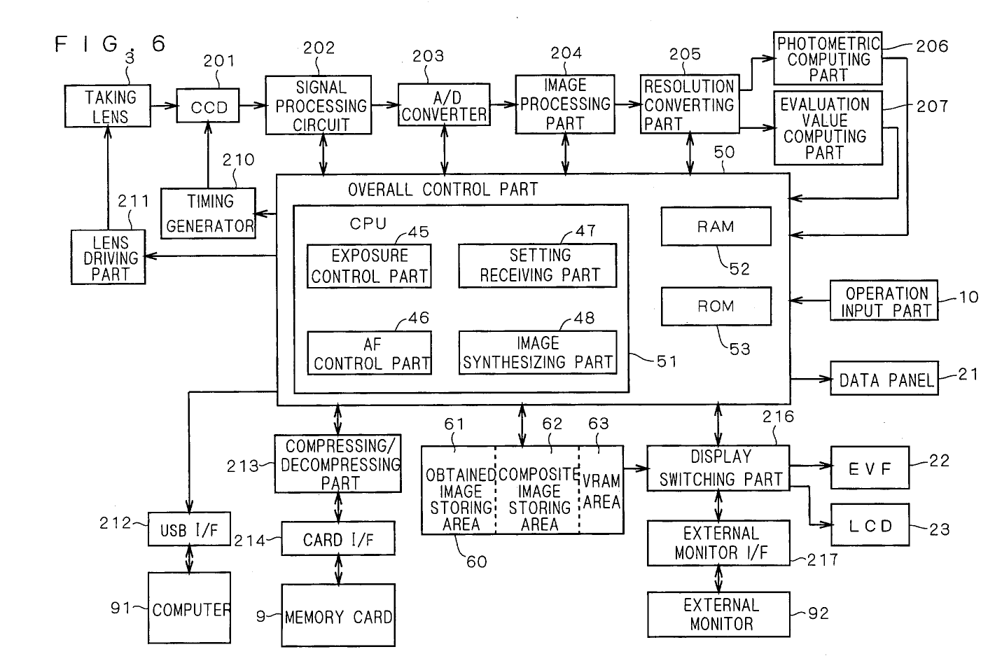

FIG. 4 is a diagram showing a display example of the setting menu of setting whether the image synthesizing function is activated or not. In the setting menu, when the item of “image synthesizing setting” is designated in the setting menu, a screen for selecting either the item of “invalid” or the item of “valid” is displayed on the LCD 23 as shown in FIG. 4. The user moves a cursor C to a desired item by operating the up and down switches 19U and 19D in the cross key 19 and can determine the item by depressing the execution button 19C. When the item of “valid” is determined, the setting of activating the image synthesizing function and generating a composite image is made.

In the digital camera 1, a plurality of methods for synthesizing a plurality of images in the image synthesizing function are prepared and set as “image synthesis modes”. By selecting one of the “image synthesis modes”, a synthesizing method employed when the image synthesizing function is activated can be selected.

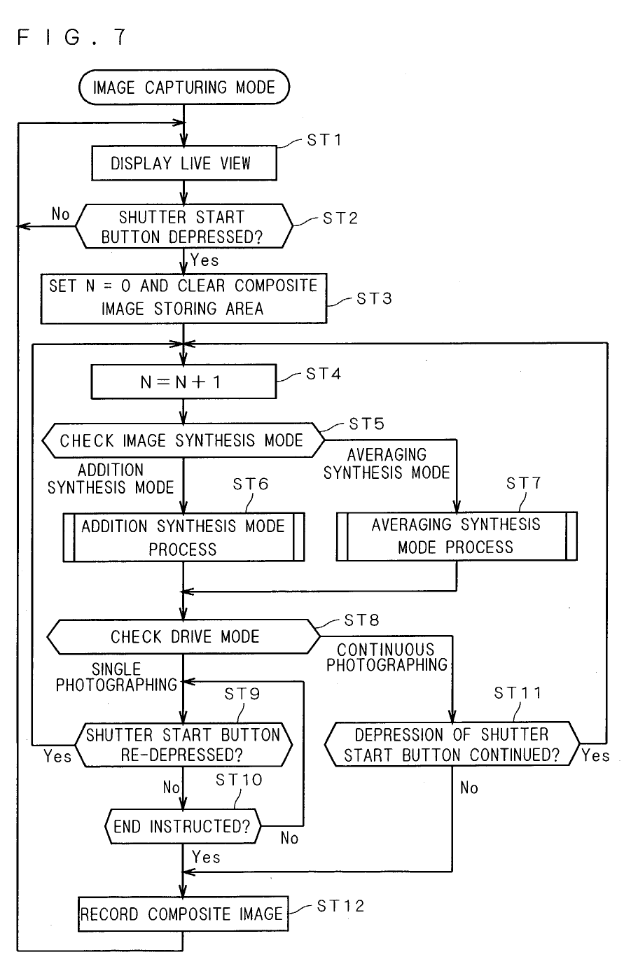

Consequently, in the case where the setting of activating the image synthesizing function is made in the screen of FIG. 4, further, a screen for selecting the “addition synthesis mode” is displayed as shown in FIG. 5. In the screen, items of “addition synthesis mode” and “averaging synthesis mode” are displayed. The “addition synthesis mode” is an image synthesis mode in which a synthesizing method of “adding respective pixel values of pixels which are respectively included in a plurality of images captured and correspond to one another” is set. On the other hand, the “averaging synthesis mode” is an image synthesizing mode in which a synthesizing method of “averaging respective pixel values of pixels which are respectively included in a plurality of images and correspond to one another” is set. The user can select any of the “image synthesis modes” by an operation similar to that in the screen of FIG. 4.

After the image synthesizing function is activated and any of the “image synthesis modes” is selected in the screens of FIGS. 4 and 5, a composite image is generated by using a synthesizing method which is set in the selected “image synthesis mode” in response to an image capturing instruction.

Referring again to FIG. 3, a quick view/erasure button 20 is provided below the cross key 19. The quick view/erasure button 20 functions as a quick view button for performing easy reproduction and display of the latest image captured in the image capturing mode and functions as an erasure button for erasing a reproduced image from the memory card 9 in the reproduction mode.

A battery space 24 is provided in the lower portion of the camera body 2. The cover of the battery space 24 is opened by a battery cover open lever 24a and four AA cells are loaded in the battery space 24. The portable digital camera 1 uses the AA cells loaded in the battery space 24 as a normal drive source. The digital camera 1 can also use, as a driving source, a direct current source from the outside supplied via a power input terminal 25 provided on the right side of the battery space 24.

A video output terminal 26 is provided on the right side of the power input terminal 25 so that an image can be transferred via a video cable and displayed on an external monitor.

A card slot 29 is provided in the camera body 2. The memory card 9 as a recording medium can be inserted into the card slot 29. Data such as a recording image to be recorded on the memory card 9 can be transferred to an external computer or the like via the memory card 9. On the contrary, various data stored in the memory card 9 in an external computer or the like can be read by the digital camera 1.

An access lamp 28 is disposed near the insertion port of the card slot 29. The access lamp 28 is driven to flicker when the memory card 9 is being accessed, thereby notifying the user of the access.

1-2. Internal Configuration of Digital Camera

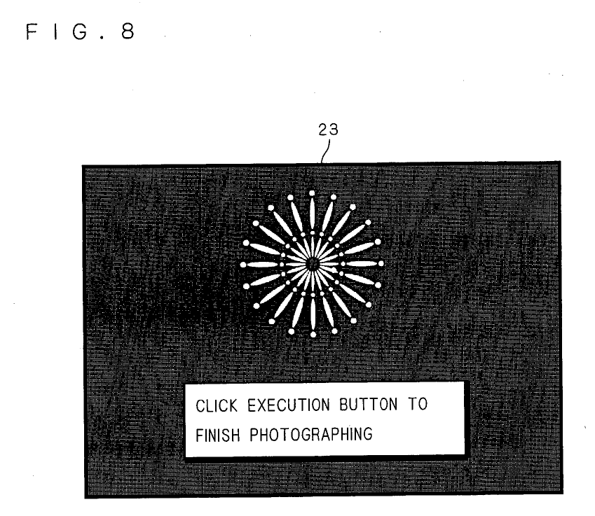

FIG. 6 is a diagram showing, as functional blocks, main internal components of the digital camera 1.

A CCD 201 is an image capturing device constructed by 2560 pixels horizontally by 1920 pixels vertically to which a color filter having a checkered pattern of R (red), G (green), and B (blue) is adhered. The CCD 201 photoelectrically converts a light image of the subject formed by the taking lens 3 into image signals of color components of R, G, and B (signals of a signal train of pixel signals received by the pixels) and outputs the image signal. The CCD 201 has, as image signal output modes, a frame mode of outputting all pixels in a normal manner, and a draft mode of reducing pixel signals in the vertical direction to ⅛ and outputting the resultant 2560 pixel signals horizontally by 240 pixel signals vertically. At the time of outputting an image for live view display in an image capturing standby state, the CCD 201 is set in the draft mode for higher processing speed. At the time of outputting an image for recording after an image capturing instruction is given, the CCD 201 is set in the frame mode.

A timing generator 210 generates a drive control signal to the CCD 201 on the basis of a signal inputted from an overall control part 50. For example, the timing generator 210 generates and outputs signals such as a timing signal for starting integration of a quantity of light received and an image signal output control signal (including a signal of changing an output mode to the draft mode or frame mode).

A signal processing circuit 202 performs a predetermined analog signal process on an image signal (analog signal) outputted from the CCD 201. The signal processing circuit 202 has therein a CDS (Correlated Double Sampling) circuit and an AGC (Automatic Gain Control) circuit, reduces noises in the image signal by the CDS circuit, and adjusts the gain by the AGC circuit, thereby adjusting the level of the image signal. A pixel signal (analog signal) outputted from the signal processing circuit 202 is converted to a digital signal of, for example, 12 bits by an A/D converter 203.

An image processing part 204 performs various image processes on an image outputted from the AID converter 203. Concretely, the image processing part 204 performs a pixel interpolating process of executing interpolation so that each of pixels of an image has data of color components of all of R, G, and B, a white balance correction for correcting unbalance in color due to an influence of color of an illumination light source to the subject, a γ correction for correcting a tone characteristic of an image by using a correction table having a predetermined γ curve, a contrast correction of emphasizing or suppressing contrast, and the like.

A resolution converting part 205 converts an image outputted from the image processing part 204 so as to have a predetermined resolution. In the image capturing standby state, the resolution converting part 205 reduces pixel signals of an image outputted from the CCD 201 at predetermined intervals to generate a live view image and also generates an image to be inputted to a photometric computing part 206 and an evaluation value computing part 207. After an image capturing instruction, the resolution converting part 205 converts the resolution of an image for recording outputted from the CCD 201 into a resolution according to the “image size” set by the function dial 16 or the like.

The photometric computing part 206 computes a photometric value for determining an f-value and shutter speed by using an image inputted from the resolution converting part 205. Concretely, the photometric computing part 206 calculates the luminance value of the subject from pixel values of the image and obtains an average value of the luminance values as a photometric value. The obtained photometric value is inputted to the overall control part 50.

The evaluation value computing part 207 computes a focus evaluation value indicative of the degree of focus by using an image inputted from the resolution converting part 205. Concretely, the absolute value of the difference between pixel values of neighboring pixels in an image is obtained and, further, a sum of the obtained differential values in the whole image is computed as an evaluation value. The obtained evaluation value is inputted to the overall control part 50.

An image memory 60 is a memory for temporarily storing an image. In the image memory 60, three storage areas of an obtained image storing area 61, a composite image storing area 62, and a VRAM area 63 are assured. The obtained image storing area 61 is a storage area for storing an image outputted from the resolution converting part 205 after the image capturing instruction, and the area 61 has a storage capacity capable of storing at least one frame of an image outputted from the CCD 201 in the frame mode. The composite image storing area 62 is a storage area for storing a composite image generated when the image synthesizing function is activated, and has the same storage capacity as that of the obtained image storing area 61. The VRAM area 63 is a storage area for storing an image to be displayed on the EVF 22 or LCD 23. In the image capturing standby state, a live view image is stored in the VRAM area 63.

A display switching part 216 switches the destination of the display image stored in the image memory 60 in accordance with a signal from the overall control part 50 based on the setting of the display switching lever 17, thereby switching display between the EVF 22 and the LCD 23. An image is outputted from the display switching part 216 also to an external monitor I/F 217. An image outputted to the external monitor I/F 217 is converted to, for example, an image signal of the NTSC system and transmitted to an external monitor 92 or the like via the video output terminal 26.

A compressing/decompressing part 213 performs a predetermined compressing process according to the JPEG method or the like on an image to be recorded on the memory card 9 and a decompressing process at the time of reproducing the image recorded on the memory card 9. A card I/F 214 is provided in the card slot 29, records an image onto the memory card 9, and reads the recorded image or the like from the memory card 9.

In the image capturing standby state of the digital camera 1, an image for live view display is obtained by the CCD 201 every predetermined time. The obtained image is subjected to predetermined processes by the signal processing circuit 202, A/D converter 203, image processing part 204, and resolution converting part 205, thereby obtaining a live view image. The live view image is stored into the VRAM area 63 in the image memory 60. The stored live view image is transmitted to the LCD 23 (or EVF 22) in a predetermined cycle. A subject image is consequently displayed as a live view on the LCD 23 (or EVF 22). The user can perform framing while recognizing the subject image.

After the image capturing instruction by the shutter start button 11, the image for recording obtained by the CCD 201 is similarly subjected to predetermined processes by the signal processing circuit 202, A/D converter 203, image processing part 204, and resolution converting part 205 and the processed image is stored into the obtained image storing area 61 in the image memory 60. In the case where the image synthesizing function is made inactive, the stored image for recording is subjected to the compressing process by the compressing/decompressing part 213 and the compressed image is recorded as a recording image to the memory card 9. On the other hand, when the image synthesizing function is activated, a composite image is generated and recorded as a recording image into the memory card 9. The details of the operation will be described later.

A lens driving part 211 drives one of the lens units in the taking lens 3 for determining the focus state of the subject image, the aperture in the taking lens 3 for determining an incident light amount, and the like on the basis of a signal inputted from the overall control part 50.

A USB I/F 212 is a communication interface conformed to the USB standard for performing communications with an external computer 91 in the communication mode. Data communications between the USB I/F 212 and the external computer 91 are performed via the USB terminal 27.

An operation input part 10 is, shown as a functional block, an operation member including the shutter start button 11, function dial 16, menu button 18, and cross key 19. A user operation received by the operation input part 10 is inputted as a signal to the overall control part 50. The data panel 21 is electrically connected to the overall control part 50 and display control on the data panel 21 is performed by the overall control part 50.

The overall control part 50 takes the form of a microcomputer and controls operations of the above-described members on the digital camera 1 in a centralized manner. The overall control part 50 includes a CPU 51 for performing various computing processes, a RAM 52 serving as a work area for computation, and a ROM 53 in which a control program or the like is stored.

The overall control part 50 realizes various functions by software. To be specific, when the CPU 51 executes computing operation in accordance with a control program stored in the ROM 53, various functions are realized. A new control program can be read from the memory card 9 as a recording medium (on which the control program has been stored) or transferred from the computer 91 for performing communications via the USB I/F 212 and stored (installed) into the ROM 53.

In FIG. 6, an exposure control part 45, an AF control part 46, a setting receiving part 47, and an image synthesizing part 48 are expressed as functional blocks of functions realized when the CPU 51 performs the computing process in accordance with the control program stored in the ROM 53.

The exposure control part 45 executes an exposure control. The exposure control part 45 determines the f-number and shutter speed (corresponding to charge accumulation time of the CCD 201, that is, exposure time) as exposure control values on the basis of a photometric value inputted from the photometric computing part 206 and transmits a predetermined signal to the lens driving part 211 and the timing generator 210 so as to achieve the determined f-number and shutter speed.

Such an exposure control value determining method varies according to “exposure mode” to be set. Specifically, in the case where “exposure mode” is “P mode”, both the shutter speed and f-number are determined on the basis of the predetermined program chart. In the case of “A mode”, only the shutter speed is determined while giving priority to aperture determined by the user. In the case of “S mode”, only the f-number is determined while giving priority to the shutter speed determined by the user. In the case where the “exposure mode” is “M mode”, the shutter speed and f-number determined by the user are used as they are and the exposure control values are not determined by the exposure control part 45.

The AF control part 46 executes a focus control for driving the lens unit to the infocus position so that the subject image enters an infocus state. Concretely, while transmitting a signal for driving the lens unit to the lens driving part 211, the AF control part 46 monitors a focus evaluation value computed by the evaluation value computing part 207 and determines, as an infocus position, the position of the lens unit where the focus evaluation value is the highest.

The setting receiving part 47 receives settings of the digital camera 1 (for example, a setting of single/sequence photographing as “drive mode”, a setting of the P, A, S, or M mode as “exposure mode”, a setting of a scene in the “scene selector” function, and the like) on the basis of a signal inputted by the operation of the operation input part 10. When the menu button 18 is depressed, the setting receiving part 47 displays the setting menu on the LCD 23 and receives settings selected in the setting menu (for example, a setting of activation/inactivation of the “image synthesizing function” and a setting of “addition synthesis mode” or “averaging synthesis mode” as “image synthesis mode”). The settings received are stored as data into the RAM 52, displayed on the data panel 21, and also supplied to the processing parts of the digital camera 1. This causes the processing parts in the digital camera 1 to operate according to the settings.

In the case where the “image synthesizing function” is activated, the image synthesizing part 48 synthesizes a plurality of pieces of image data obtained by the CCD 201 to thereby generate a composite image. As the synthesizing method, the synthesizing method in the set “image synthesis mode” (“addition synthesizing mode” or “averaging synthesis mode”) is employed.

1-3. Outline of Operation of Digital Camera

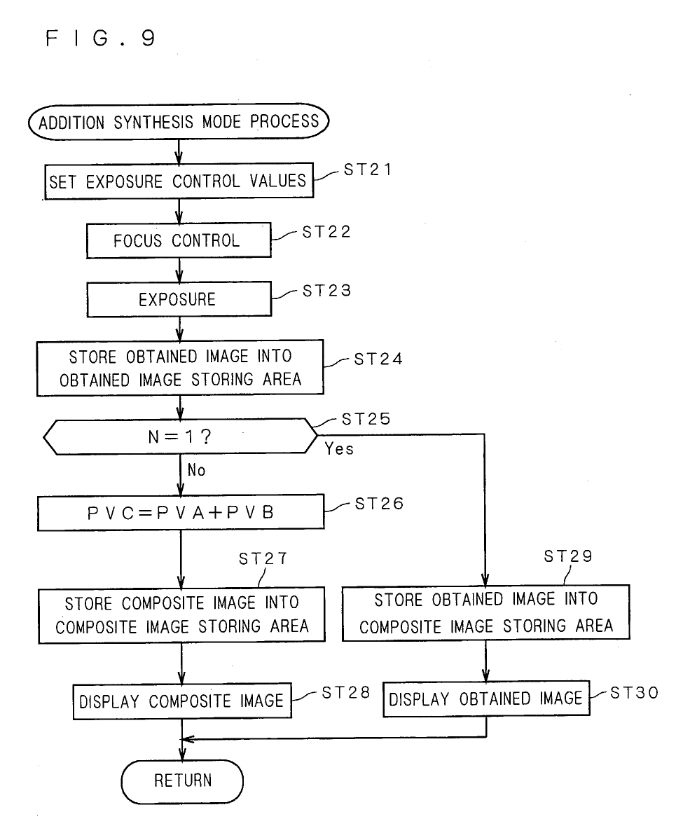

An outline of the operation in the image capturing mode of the digital camera 1 when the setting of activating the image synthesizing function is made will now be described. FIG. 7 is a diagram showing the flow of operation of the digital camera 1.

When the image capturing mode is set, the digital camera 1 enters the image capturing standby state. Until the shutter start button 11 is depressed (so far as No indicated in step ST2), an image for live view is received by the CCD 201 every predetermined time and a live view image is displayed on the LCD 23 (step ST1).

When the shutter start button 11 is depressed in such a state, as an initializing process for generating a composite image, an internal counter N is set to 0 and the composite image storing area 62 in the image memory 60 is cleared (step ST3).

Subsequently, the internal counter N is incremented. The internal counter N indicates the number of images obtained to be synthesized. In the following processes, steps ST6 or ST7 to be described below is repeated, so that a plurality of images to be synthesized are obtained by the CCD 201. Before an image to be synthesized is obtained, the internal counter N is incremented each time (step ST4).

Subsequently, the setting of “image synthesis mode” is checked (step ST5). In the case of “addition synthesis mode”, an addition synthesis mode process (step ST6) is performed. In the case of “averaging synthesis mode”, an averaging synthesis mode process (step ST7) is performed. In the process, one image to be synthesized is obtained and a synthesizing process according to the “image synthesis mode” is performed. (However, in the case of N=1, the synthesizing process is not performed. The details will be described later.)

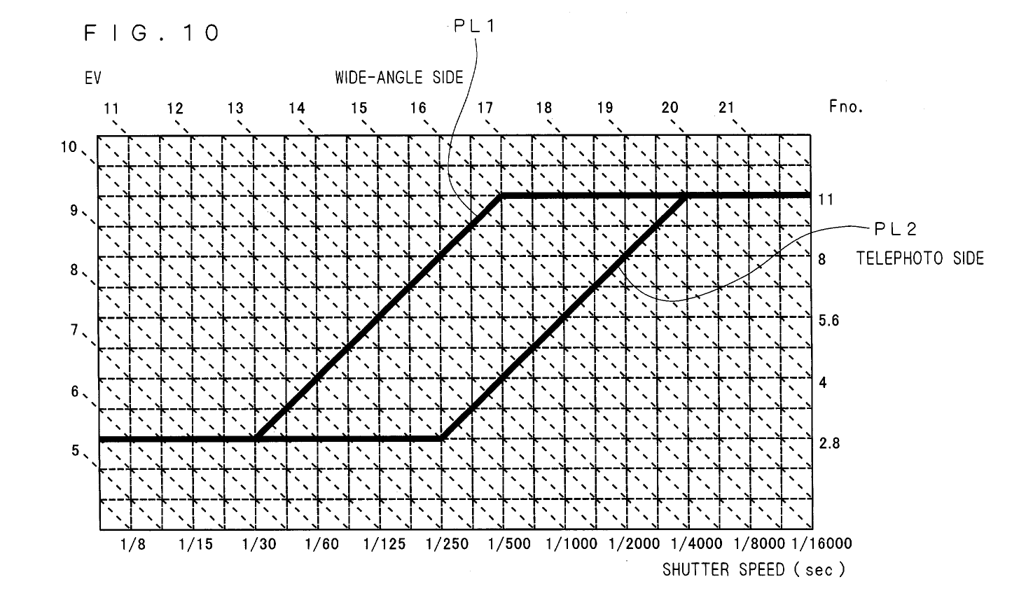

After completion of the process, the setting of “drive mode” is checked (step ST8). In the case where “single photographing” is set as “drive mode”, re-depression of the shutter start button 11 (step ST9) and an end instruction (step ST10) are sequentially determined, and the digital camera 1 waits for an operation. The end instruction is an instruction to stop obtaining a new image to be synthesized. As shown in FIG. 8, a message of accepting the end instruction is displayed on the LCD 23. By depression of the execution button 19C, the end instruction is accepted.

When the shutter start button 11 is re-depressed in this state (Yes in step ST9), the process returns to step ST4 where the internal counter N is incremented. After that, a new image to be synthesized is obtained and the synthesizing process according to the “image synthesis mode” is performed (step ST6 or ST7). In the case where “single photographing” is set as “drive mode” as described above, the user arbitrarily determines timings of obtaining a plurality of images to be synthesized. It is preferable to display a subject image on the LCD 23 (live view display) so that framing can be performed.

In the case where the end instruction is accepted (Yes in step ST10), the process advances to step ST12 where a composite image generated by the synthesizing process is subjected to the compressing process by the compressing/decompressing part 213, and the compressed image is recorded in the memory card 9. After recording the composite image, the process returns again to the image capturing standby state (steps ST1 and ST2).

On the other hand, when the “drive mode” is “continuous photographing” in step ST8, whether the depression of the shutter start button 11 is continued or not is determined (step ST11). If Yes, the process returns to step ST4 where the internal counter N is incremented. After that, a new image to be synthesized is obtained and the synthesizing process according to the “image synthesis mode” is performed (step ST6 or ST7). In the case where “continuous photographing” is set as “drive mode”, while the shutter start button 11 is depressed, a plurality of images to be synthesized which are sequential with respect to time are obtained.

In the case where depression of the shutter start button is canceled, a composite image generated by the synthesizing process is subjected to the compressing process by the compressing/decompressing part 213, and the compressed image is recorded in the memory card 9. After recording the composite image, the process returns again to the image capturing standby state (steps ST1 and ST2).

1-4. Addition Synthesizing Mode

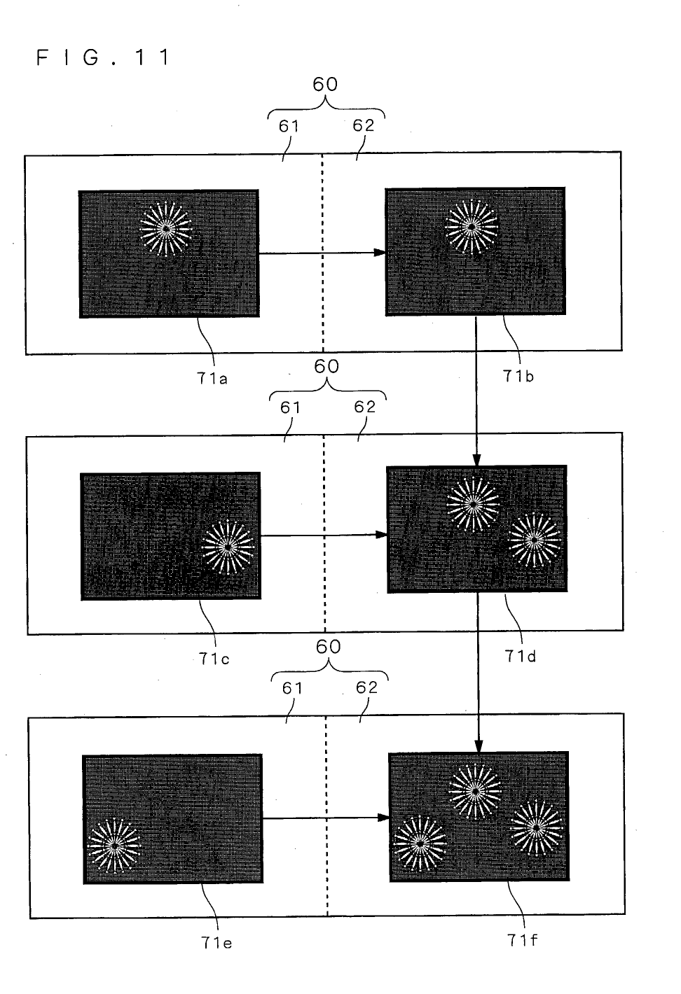

The details of the addition synthesizing (step ST6 in FIG. 7) will now be described. FIG. 9 is a diagram showing the detailed flow of the addition synthesis mode process.

First, exposure control values (f-number and shutter speed) are determined by the exposure control part 45 on the basis of a photometric value inputted from the photometric computing part 206 and the “exposure mode”. Signals are transmitted to the lens driving part 211 and the timing generator 210 so as to achieve determined exposure control values. The same program chart that is used in the case of inactivating the image synthesizing function is referred to (step ST21).

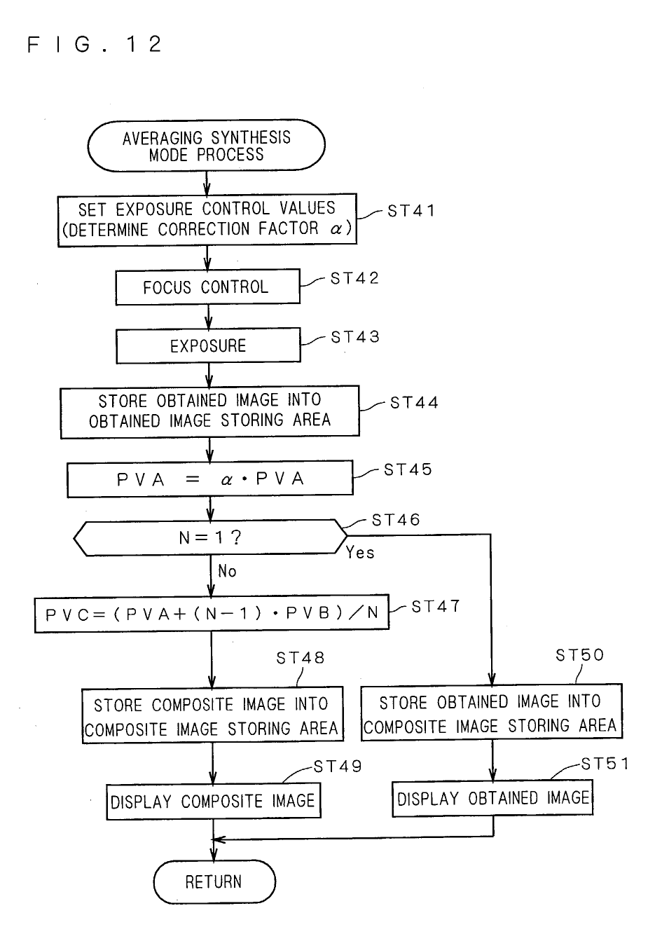

FIG. 10 is a diagram showing an example of a program chart which is referred to when “P mode” is set as the “exposure mode” in the “addition synthesis mode”. The program chart shows the relation between f-number (2.8 to 11) and shutter speed (exposure time of ⅛ to 1/16000 second). In the digital camera 1, the program chart is changed according to the focal length of the taking lens 3. In FIG. 10, reference numeral PL1 denotes a program chart of the case where the focal length of the taking lens 3 is relatively short (wide angle side) and reference numeral PL2 expresses a program chart of the case where the focal length of the taking lens 3 is relatively long (telephoto side). As the focal length of the taking lens 3 becomes longer (to the telephoto side), the tendency of occurrence of a camera shake increases. As shown in FIG. 10, by setting the shutter speed to be relatively high on the tele side, occurrence of a camera shake is prevented.

After the exposure control values are determined by the exposure control part 45, the AF control part 46 performs a focus control so that a subject image enters an infocus state (step ST22). Exposure (charge accumulation) is performed on the CCD 201 for the set exposure time (step ST23).

An image obtained by the CCD 201 (hereinbelow, also called an “obtained image”) is subjected to predetermined processes by the signal processing circuit 202, A/D converter 203, image processing part 204, and resolution converting part 205, and the processed image is stored into the obtained image storing area 61 in the image memory 60 (step ST24).

The image synthesizing part 48 determines whether the obtained image is the first image to be synthesized or not, concretely, whether “N=1” or not (step ST25). In the case where the obtained image is the first image, there are no other images to be synthesized. Consequently, the obtained image is stored as it is in the composite image storing area 62 in the image memory 60 (step ST29). The obtained image is displayed on the LCD 23 for predetermined time so as to show the image obtained to the user (step ST30).

On the other hand, when the obtained image is not the first image, the image synthesizing part 48 reads the obtained image stored in the obtained image storing area 61 and an image (hereinafter, referred to as “temporary composite image”) stored in the composite image storing area 62. Computation of the following equation 1 is executed on each of corresponding pixels in two images, thereby generating a composite image.

PVC=PVA+PVB Equation 1

In Equation 1, PVA denotes a pixel value of the obtained image, PVB denotes a pixel value of the temporary composite image, and PVC indicates a pixel value of a composite image to be generated. That is, the composite image is generated by simply adding a pixel value in the obtained image and a corresponding pixel value in the temporary composite image (step ST26).

The generated composite image is stored as a temporary composite image in the next synthesizing process into the composite image storing area 62 (step ST27) and displayed on the LCD 23 for predetermined time so as to be shown to the user (step ST28).

IF “Yes” in step ST9 or ST11 in FIG. 7, the series of processes of obtaining a new image to be synthesized, computation of Equation 1, and the like is repeated. By repetition of such processes, finally, a composite image to be obtained is stored in the composite image storing area 62.

The composite image generated as described above is obtained by simply adding a plurality of images to be synthesized. Consequently, the luminance and saturation of an image to be synthesized do not deteriorate, so that a composite image in which the colors and vividness of subjects do not deteriorate is generated. On the other hand, when such simple addition is executed on pixel values in the case of a subject of relatively high luminance, the possibility that overflow occurs in a composite image increases. Therefore, the “addition synthesis mode” is suitable for an image in which a main subject is bright and clear and the background is dark such as an image of buildings, fireworks, and the like in the night.

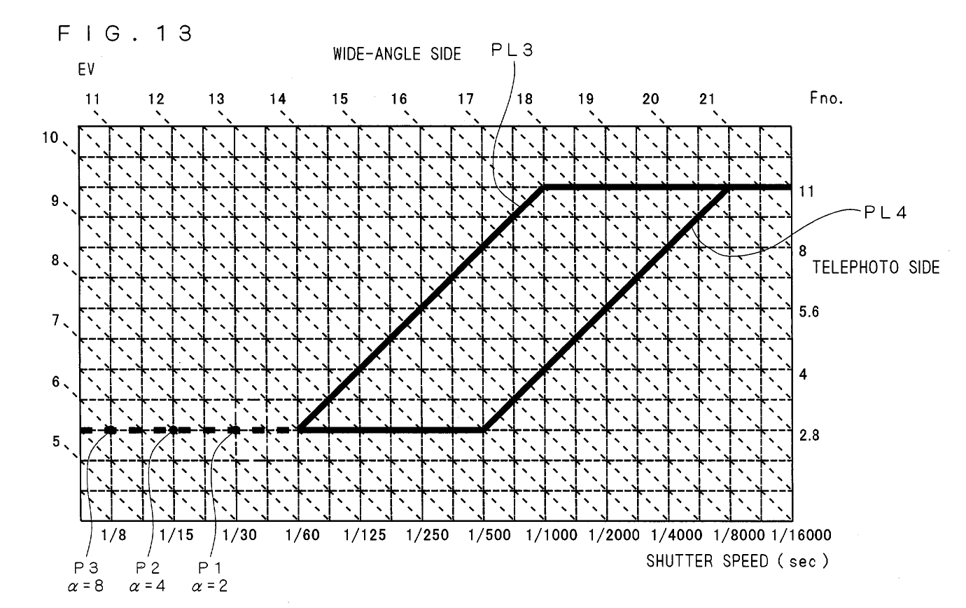

FIG. 11 is a diagram for describing a process of generating a composite image in the “addition synthesis mode” in the case where the main subject is a firework, as an example. In the description, “single photographing” is set as “drive mode”.

First, when an image 71a including a firework is obtained by depression of the shutter start button 11 by the user, the obtained image 71a is stored into the obtained image storing area 61 in the image memory 60. At this time point, there are no images to be synthesized, so that the obtained image 71a is stored as it is into the composite image storing area 62 and, thereafter, used as a temporary composite image 71b.

Subsequently, when a new image 71c including another firework different from that of the obtained image 71a is obtained by depression of the shutter start button 11, the obtained image 71c is similarly stored into the obtained image storing area 61. The obtained image 71c and the temporary composite image 71b are read and added to each other, thereby generating a composite image 71d including the two fireworks. The generated composite image 71d is stored in the composite image storing area 62 and, thereafter, used as the temporary composite image 71d.

Further, when a new image 71e including another firework is obtained by depression of the shutter start button 11, the obtained image 71e is also similarly stored into the obtained image storing area 61. The obtained image 71e and the temporary composite image 71d are read and added to each other, thereby generating a composite image 71f including the three fireworks. The generated composite image 71f is also similarly stored into the composite image storing area 62.

When an end instruction is received from the user, the composite image 71f stored in the composite image storing area 62 at the time point becomes a composite image to be obtained and is recorded in the memory card 9. The composite image 71f is an image in which the luminance, saturation, and the like of the fireworks included in the three images 71a, 71c, and 71e to be synthesized are reflected as they are.

1-5. Averaging Synthesis Mode

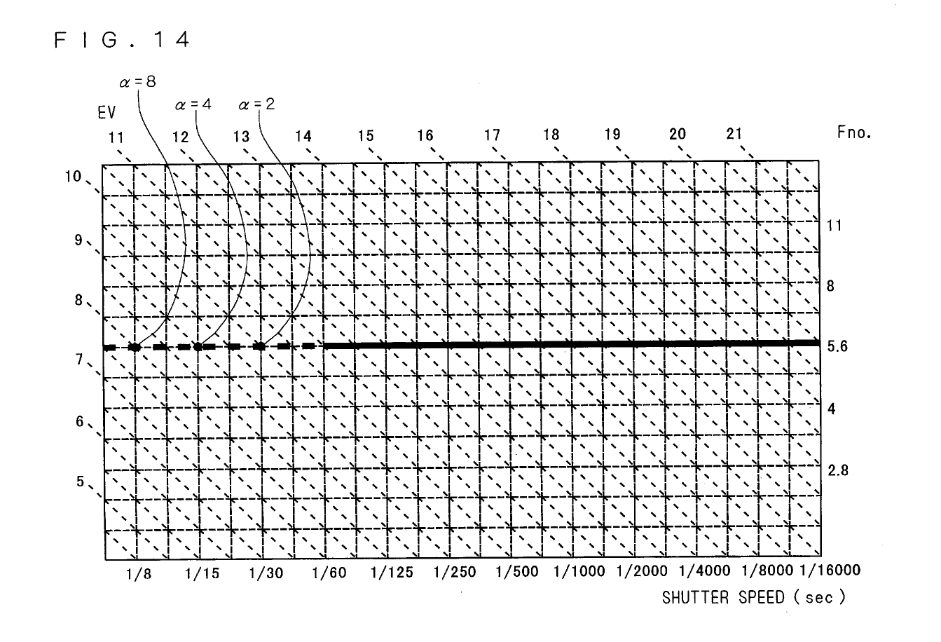

The details of the averaging synthesis mode process (step ST7 in FIG. 7) will now be described. FIG. 12 is a diagram showing the detailed flow of the averaging synthesis mode process.

First, exposure control values (f-number and shutter speed) are determined by the exposure control part 45 on the basis of the photometric value inputted from the photometric computing part 206 and the “exposure mode”. Signals are transmitted to the lens driving part 211 and the timing generator 210 so as to achieve the determined exposure control values (step ST41).

The “averaging synthesis mode” is suitable for a subject of relatively high luminance, differently from the “addition synthesis mode”. An image to be synthesized is preferably an image in which a momentary action and state of a subject are captured so that a subject image is not moved during exposure. In the “averaging synthesis mode”, therefore, a program chart different from that in the “addition synthesis mode” is referred to, and the shutter speed (exposure time) is set to predetermined reference time or shorter.

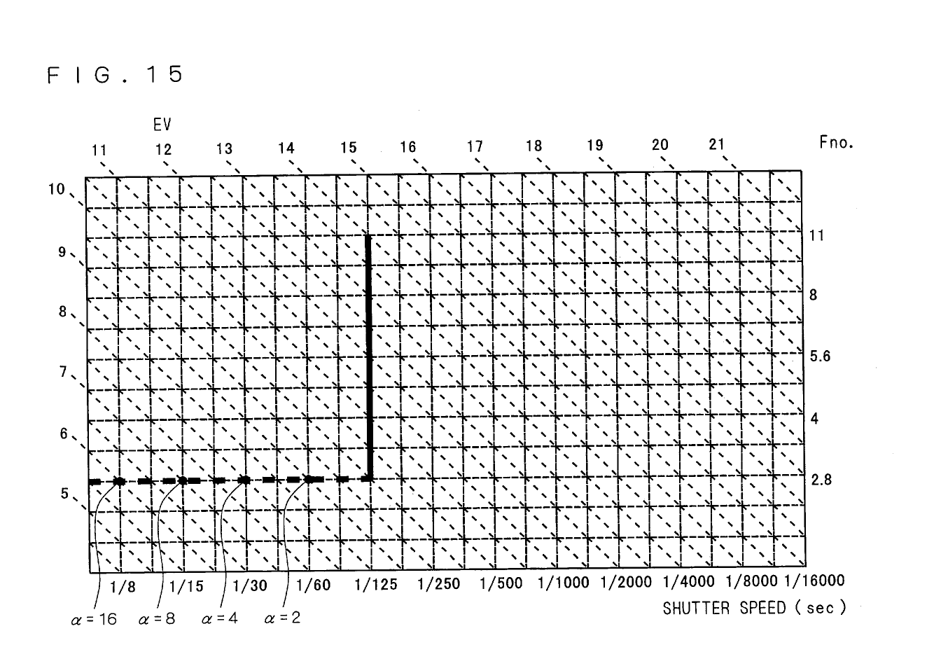

FIG. 13 is a diagram showing an example of a program chart referred to when “P mode” is set as “exposure mode” in the “averaging synthesis mode”. In FIG. 13, reference numeral PL3 denotes a program chart of the case where the focal length of the taking lens 3 is relatively short (wide angle side), and reference numeral PL4 denotes a program chart of the case where the focal length of the taking lens 3 is relatively long (telephoto side). As understood by comparison with the program charts PL1 and PL2 in the “addition synthesis mode” shown in FIG. 10, the program charts PL3 and PL4 of FIG. 13 are shifted to the right side on which the shutter speed is higher, relative to the program charts PL1 and PL2. Further, in the portion indicated by the broken line in FIG. 13, the shutter speed is forcedly set to the predetermined time (1/60 second) and is always set to the predetermined time or shorter. As described above, in the “averaging synthesis mode”, the shutter speed is set to be relatively high. Consequently, a movement of a subject image during exposure in an image to be synthesized is suppressed.

In the portion indicted by the broken line in FIG. 13, the shutter speed is forcedly set to the predetermined reference time. It is therefore expected that an image to be obtained is captured with underexposure. Concretely, at a point P1 corresponding to EV (corresponding to the photometric value)=8, the proper shutter speed is 1/30 second. However, since the shutter speed is set to 1/60 second, underexposure by one step is expected. Similarly, at a point P2 corresponding to EV=7, underexposure by two steps is expected. At a point P3 corresponding to EV=6, underexposure by three steps is expected.

When underexposure is expected as described above, the exposure control part 45 sets a correction factor α for correcting the underexposure. The correction factor α is determined by the following Equation 2 where k denotes the expected number of steps of the underexposure.

α=2^{k} Equation 2

That is, the correction factor α is the k-th power of 2. For example, at the point P1, α is set to 2. At the point P2, α is set to 4. At the point P3, α is set to 8.

The shutter speed is limited similarly also in the case where the “exposure mode” is “A mode”. FIG. 14 is a diagram showing a program chart of the case where the f-number is determined as 5.6 by the user when the “exposure mode” is “A mode”. In FIG. 14 as well, in a portion indicated by a broken line, the shutter speed is forcedly set to predetermined reference time (1/60 second) and the correction factor α is determined according to the expected number of steps of underexposure.

When the “exposure mode” is “S mode”, the shutter speed is a value determined by the user. In the case where underexposure is expected even if the f-number is set to an open aperture value (2.8 in the preferred embodiment), the correction factor α is set. FIG. 15 is a diagram showing a program chart in the case where “S mode” is set as “exposure mode” and the shutter speed is determined as 1/125 second by the user. In FIG. 15, even if the f-number is set to an open value (2.8), in a portion of underexposure indicated by a broken line, the correction factor α is determined in accordance with the expected number of steps of underexposure.

In the case where no underexposure is expected, the correction factor α is set to “1” an initial value. When the “exposure mode” is “M mode”, both the f-number and shutter speed are determined by the user and the correction factor α of “1” is unchanged.

Referring again to FIG. 12, after the exposure control value and the correction factor α are determined by the exposure control part 45, focusing control is performed by the AF control part 46 to achieve focus on the subject (step ST42). The CCD 201 is exposed to light for the only set exposure time (step ST43), a captured image is subjected to the predetermined processes by the signal processing circuit 202, A/D converter 203, image processing part 204, and resolution converting part 205, and the processed image is stored in the obtained image storing area 61 (step ST44). In the γ correction performed in the image processing part 204, a correction table achieving a γ curve different from that in the “addition synthesis mode” may be used.

The obtained image is read by the image synthesizing part 48 and computation of the following equation 3 is executed.

PVA=α·PVA Equation 3

Specifically, the pixel value PVA in the obtained image is multiplied by the correction factor α and the brightness of the obtained image is adjusted so as to correct underexposure. It makes the obtained image an image of proper exposure (step ST45).

After that, whether the obtained image is the first image to be synthesized or not is determined by the image synthesizing part 48 (step ST46). If “Yes”, which indicates that there is no another image to be synthesized, the obtained image is stored as it is in the composite image storing area 62 (step ST50). To show the image obtained to the user, the obtained image is displayed on the LCD 23 for predetermined time (step ST51).

If the obtained image is not the first image, the obtained image stored in the obtained image storing area 61 and the temporary composite image stored in the composite image storing area 62 are read by the image synthesizing part 48. Corresponding pixels in the two images are subjected to computation of the following equation 4, thereby generating a composite image.

PVC=(PVA+(N−1)·PVB)/N Equation 4

Specifically, by averaging pixel values of pixels which are respectively included in the obtained image and a group of synthesized images as the temporary composite image and correspond to each other, a composite image is generated (step ST47).

The generated composite image is stored as a temporary composite image in the next synthesizing process into the composite image storing area 62 (step ST48) and is also displayed on the LCD 23 for predetermined time to show the composite image to the user (step ST49).

If “Yes” in step ST9 or ST11 in FIG. 7, the series of processes of setting of the correction factor α, acquisition of a new image to be synthesized, computation of Equation 4, and the like is repeated. By repeating such processes, finally, the composite image to be obtained is stored in the composite image storing area 62.

The composite image generated is obtained by averaging a plurality of images to be synthesized. Consequently, occurrence of an overflow of a pixel value in a composite image can be avoided. Even in the case of a subject of relatively high luminance, a composite image of proper brightness can be generated. Therefore, the “averaging synthesis mode” is suitable for a subject of relatively high luminance.

Since the shutter speed (exposure time) is set to the predetermined reference time or shorter, even when a subject is moving, a movement of a subject image in each of the plurality of images to be synthesized can be suppressed. Therefore, the “averaging synthesis mode” can be also applied to a subject which is moving.

Particularly, in the case where the “drive mode” is set to “continuous photographing”, a composite image indicating sequential movement of the subject which is moving can be generated. For example, a composite image indicative of the flow of a form in sports such as golf can be easily generated. Since the shutter speed is set to be relatively high, the number of images obtained per unit time by continuous photographing can be also increased.

When the shutter speed is set to the predetermined reference time or shorter, even in the case where an image to be synthesized is underexposed, the exposure can be corrected to be proper. Specifically, even when the shutter speed is set to be equal to or shorter than the predetermined reference time, each of a plurality of images to be synthesized is properly exposed. Thus, luminance of a composite image generated by averaging can be also made proper.

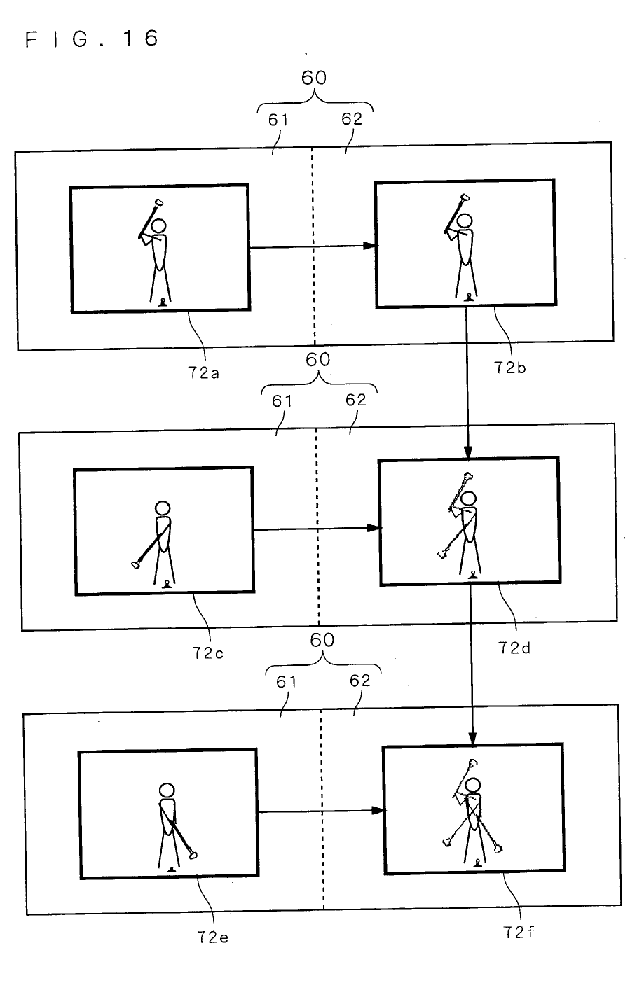

FIG. 16 is a diagram showing the process of generating a composite image in the “averaging synthesis mode” in the case where the main subject is a human being who is playing golf as an example. In the description, the “drive mode” is set to “continuous photographing”.

First, when a first image 72a in continuous photographing is obtained by depression of the shutter start button 11 by the user, the obtained image 72a is stored into the obtained image storing area 61 in the image memory 60. At this time point, there is no other image to be synthesized, so that the obtained image 72a is stored as it is in the composite image storing area 62 and, after that, used as a temporary composite image 72b.

When the depression of the shutter start button 11 is continued and a second image 72c is obtained, the obtained image 72c is also similarly stored into the obtained image storing area 61. The obtained image 72c and the temporary composite image 72b are read and the computation of Equation 4 is executed, thereby generating a composite image 72d. The generated composite image 72d is stored in the composite image storing area 62 and, after that, used as a temporary composite image 72d.

Further, when the depression of the shutter button 11 is continued and a third image 72e is obtained, the obtained image 72e is also similarly stored into the obtained image storing area 61. The obtained image 72e and the temporary composite image 72d are read and computation of Equation 4 is executed, thereby generating a composite image 72f. The generated composite image 72f is also similarly stored in the composite image storing area 62.

When the depression of the shutter start button 11 is canceled, the composite image 72f stored in the composite image storing area 62 at this time point becomes a composite image to be obtained and is recorded into the memory card 9. The composite image 72f becomes an image obtained by averaging the three images 72a, 72c, and 72e to be synthesized and the movement of the subject which is moving is shown.

The first preferred embodiment has been described above. The digital camera 1 has the “addition synthesis mode” and “averaging synthesis mode” as the “image synthesis modes” in each of which a synthesizing method for synthesizing a plurality of images is set. The user can select a desired mode from the “image synthesis modes” in accordance with a subject. Thus, a composite image which exhibits an effect suitable for each subject can be generated.

Since a composite image is generated in response to an image capturing instruction with the shutter start button 11, a composite image can be easily generated without accompanying a complicated operation.

Each time an image to be synthesized is obtained, synthesis on the image is performed and the generated composite image (temporary composite image) is stored into the composite image storing area 62. Consequently, the required storage area such as the image memory 60 can be reduced as compared with the case of obtaining all of a plurality of images to be synthesized and generating a composite image.

2. Second Preferred Embodiment

A second preferred embodiment of the present invention will now be described. In the first preferred embodiment, the “image synthesis mode” is voluntarily selected by the user. Alternatively, the “image synthesis mode” may be automatically selected by the digital camera 1 on the basis of image capturing control settings (“exposure mode”, “drive mode”, “scene selector”, and the like) regarding acquisition of images of the digital camera 1. In this manner, the operability of the digital camera 1 can be improved.

In the digital camera 1 of the preferred embodiment, the “image synthesis mode” is selected on the basis of the “exposure mode”. The configuration of the digital camera 1 of the second preferred embodiment is similar to that shown in FIGS. 1 to 3 and FIG. 6, so that the different points will be mainly described.

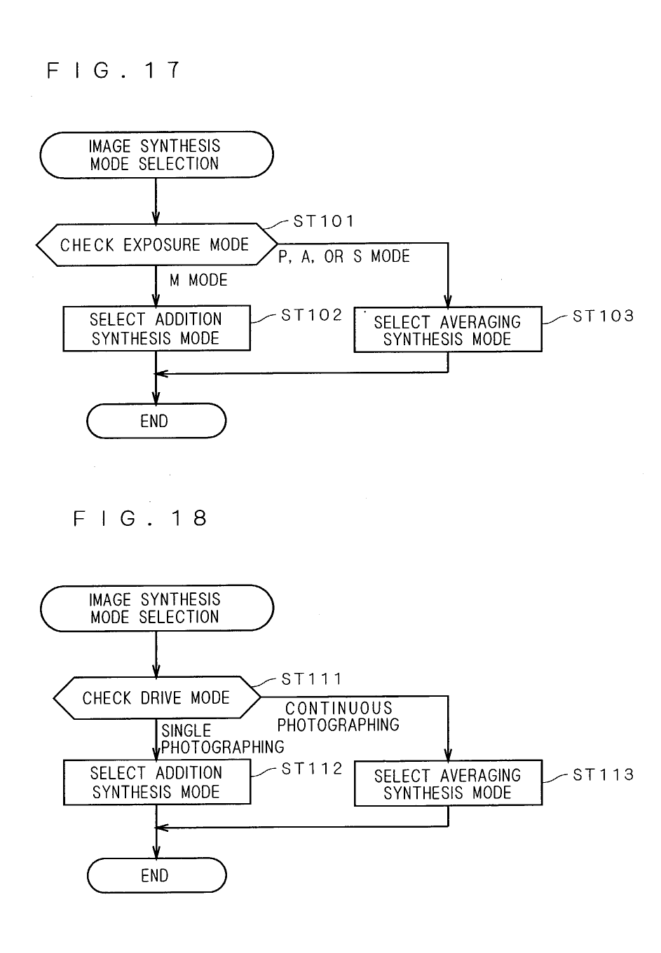

In the digital camera 1 of the second preferred embodiment, when an item of “image synthesis setting” is set in the setting menu, in a manner similar to the first preferred embodiment, a screen for selecting whether the image synthesizing function shown in FIG. 4 is activated or not is displayed. When the setting of activating the image synthesizing function is made on the screen, the screen for selecting the “image synthesis mode” in FIG. 5 is not displayed but an image synthesis mode selecting process shown in FIG. 17 is performed by the setting receiving part 47.

Specifically, the “exposure mode” set by the user is checked (step ST101). When the exposure mode is “P mode”, “A mode” or “S mode”, the “averaging synthesis mode” is selected (step ST103). When the exposure mode is the “M mode”, the “addition synthesis mode” is selected (step ST102). That is, in the “exposure mode” in which the digital camera 1 determines at least one of the f-number and the shutter speed, the “averaging synthesis mode” is selected. In the “exposure mode” in which the user determines both the f-number and the exposure time, the “addition synthesis mode” is selected.

The image synthesis mode selecting process is executed also in the case where the “exposure mode” is changed by the user and the “image synthesis mode” corresponding to the “exposure mode” is always selected. When the shutter start button 11 is depressed by the user, an operation similar to that in the first preferred embodiment is executed and a composite image according to the “image synthesis mode” is generated.

When the “exposure mode” is set to any of the “P mode”, “A mode”, and “S mode”, an image to be synthesized is properly exposed. Consequently, if a plurality of images to be synthesized are simply added, there is the possibility that overflow occurs in the pixel value of the composite image. Therefore, by setting the “averaging synthetic mode” as the “image synthesis mode”, such an overflow can be prevented. Since both an exposure control value and brightness of a composite image are adjusted by the digital camera 1 by such settings, even a user of relatively low familiarity with the digital camera can generate a proper composite image.

On the other hand, when the “M mode” is set as the “exposure mode”, the user can set a desired exposure control value, so that an image to be synthesized can be intentionally underexposed. Therefore, by setting the “addition synthesis mode” of simply performing addition, the preferences of the user can be properly reflected in the composite image generated.

3. Third Preferred Embodiment

A third preferred embodiment of the present invention will now be described. In the preferred embodiment, the “image synthesis mode” is selected on the basis of the “drive mode”. The configuration of the digital camera 1 of the third preferred embodiment is similar to that shown in FIGS. 1 to 3 and FIG. 6.

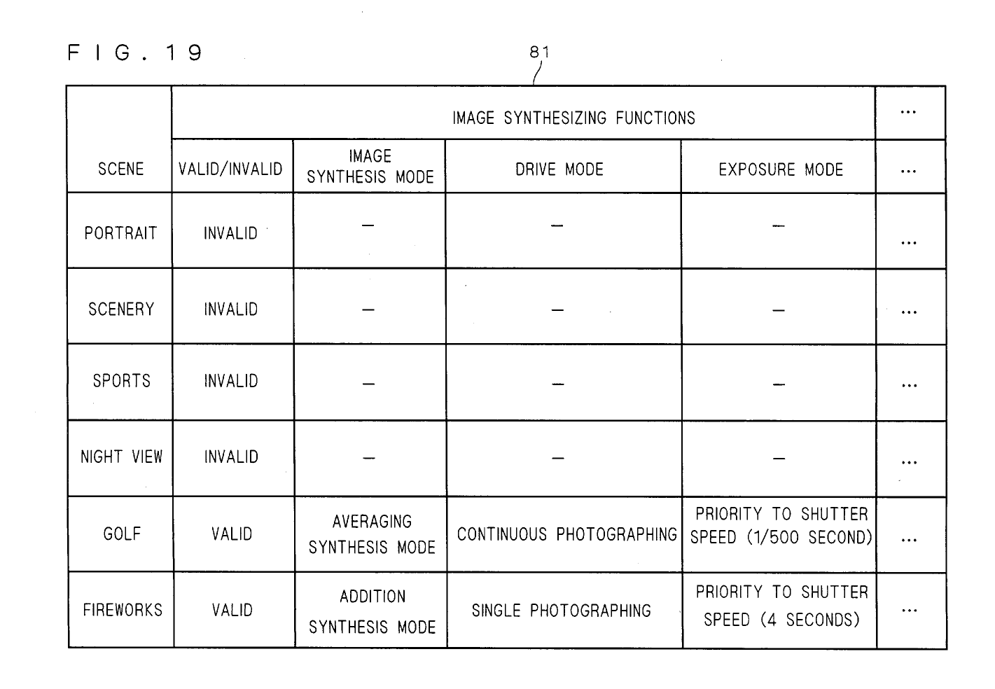

In the digital camera 1 of the preferred embodiment, when the setting of activating the image synthesizing function is made in the screen shown in FIG. 4, the image synthesis mode selecting process shown in FIG. 18 is performed by the setting receiving part 47.

Specifically, the “drive mode” set by the user is checked (step ST111). When the drive mode is “continuous photographing”, “averaging synthesis mode” is selected (step ST113). When the drive mode is “single photographing”, the “addition synthesis mode” is selected (step ST112). The image synthesis mode selecting process is executed also in the case where the “drive mode” is changed by the user so that the “image synthesis mode” corresponding to the “drive mode” is always selected.

When the shutter start button 11 is depressed by the user, operations similar to those in the first preferred embodiment are performed and a composite image according to the “image synthesis mode” is generated. In the “addition synthesis mode”, the “single photographing” operation is performed. In the “averaging synthesis mode”, the “continuous photographing” operation is performed.

Generally, when the “continuous photographing” is set as the “drive mode”, the object is often a subject which is moving. The “averaging synthesis mode” is suitable to generate a composite image of a subject which is moving. Therefore, by setting the “averaging synthesis mode” when “continuous photographing” is set, a composite image showing the motion of the subject which is moving can be generated without accompanying complicated operation.

On the other hand, when the “single photographing” is set as the “drive mode”, a timing of obtaining an image to be synthesized can be set and relatively long exposure time can be set. Thus, the “single photographing” is suitable for a subject such as a firework. The “addition synthesis mode” is suitable to generate a composite image of a subject such as a firework. Therefore, by setting the “addition synthesis mode” when the “single photographing” is set, a composite image of a subject such as a firework can be generated without accompanying a complicated operation.

4. Fourth Preferred Embodiment

A fourth preferred embodiment of the present invention will now be described. In the preferred embodiment, the “image synthesis mode” is selected on the basis of a scene selected in the “scene selector” function. The configuration of the digital camera 1 of the fourth preferred embodiment is similar to that shown in FIGS. 1 to 3 and FIG. 6.

In the digital camera 1 of the preferred embodiment, the setting of whether the image synthesizing function is activated or not is not made in the setting menu, but by selecting a scene in the “scene selector”, both whether the image synthesizing function is activated or not and the “image synthesis mode” are determined.

In the digital camera 1 of the preferred embodiment, as scenes which can be selected by the “scene selector”, in addition to “portrait”, “scenery”, “sports” and “night view”, “golf” and “firework” can be selected. A control performed in each scene is written in a scene control table which is prestored in the ROM 53. When a scene is selected by the scene selection button 13, the setting receiving part 47 sets an image capturing control by referring to the scene control table, so that the image capturing control according to the selected scene can be performed after that.

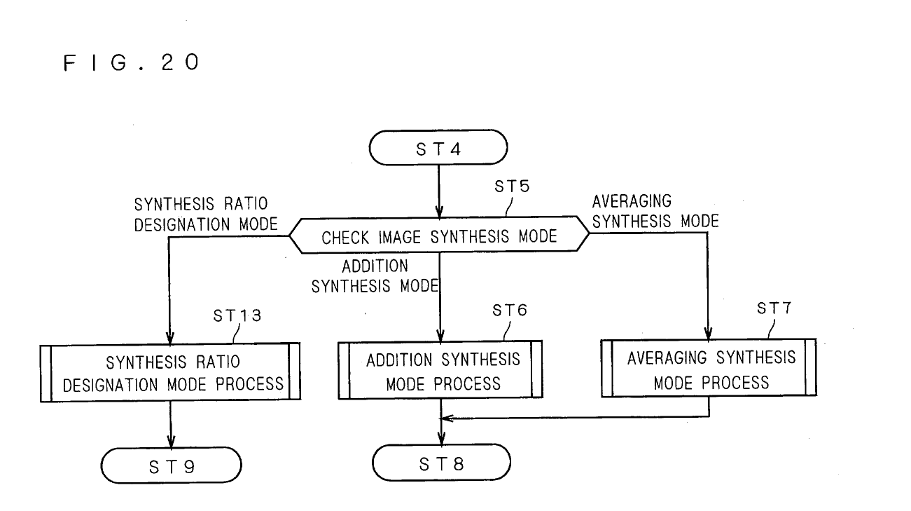

FIG. 19 is a diagram showing a part of the image synthesizing function in such a scene control table 81. As shown in the diagram, in the scene control table 81, each of the scenes of “portrait”, “scenery”, “sports”, “night view”, “golf”, and “firework” is associated with the settings of “valid/invalid” of the image synthesizing function, “image synthesis mode”, “drive mode”, and “exposure mode”.

As shown in the scene control table 81, when “portrait”, “scenery”, “sports”, and “night view” are selected as scenes, a setting of making the image synthesizing function “invalid” (that is, inactivating) is made. On the other hand, when “golf” or “firework” is selected as a scene, a setting of making the image synthesizing function “valid” (that is, activating) is made and “image synthesis mode”, “drive mode”, and “exposure mode” are set in accordance with the scene control table 81.

Concretely, when “golf” is selected, “averaging synthesis mode” is set as the “image synthesizing mode”. “Continuous photographing” is set as the “drive mode”, and “S mode (in which the shutter speed is set to 1/500 second)” is set as “exposure mode”. The settings are optimum to generate a composite image when the main subject is e.g., a human being who is playing golf as shown in FIG. 16. On the other hand, when “firework” is selected, the “addition synthesis mode” is set as the “image synthesis mode”, “single photographing” is set as the “drive mode”, and “S mode (in which shutter speed is set to 4 seconds)” is set as the “exposure mode”. The settings are optimum to generate a composite image when the main subject is, e.g., a firework as shown in FIG. 11.

When the shutter start button 11 is depressed by the user, operations similar to those in the first preferred embodiment are performed in accordance with the various settings made according to the scene, and a composite image is generated.

As described above, in the digital camera 1 of the fourth preferred embodiment, only by setting the scene of the “scene selector”, the settings of “valid/invalid” of the image synthesizing function, “image synthesis mode”, “drive mode”, and “exposure mode” are determined. Therefore, proper settings can be determined according to a subject by a very simple operation, and a composite image which exhibits an effect suitable for each subject can be easily generated.

5. Fifth Preferred Embodiment

A fifth preferred embodiment of the present invention will now be described. The digital camera 1 of the foregoing preferred embodiments has the two “image synthesis modes” of the “addition synthesis mode” and “averaging synthesis mode”. The digital camera 1 may have an “image synthesis mode” in which another synthesizing method is set.

The digital camera 1 of the fifth preferred embodiment has, as the “image synthesis modes”, not only the “addition synthesis mode” and “averaging synthesis mode” but also a “synthesis ratio designation mode” capable of setting a synthesis ratio of each of a plurality of images to be synthesized. The configuration of the digital camera 1 of the fifth preferred embodiment is similar to that shown in FIGS. 1 to 3 and FIG. 6. A method of selecting whether the image synthesizing function is activated or not and which mode is set as the “image synthesis mode” is similar to that of the first preferred embodiment. Specifically, when a setting of activating the image synthesizing function is made in the screen of FIG. 4, the “synthesis ratio designation mode” is also displayed as a selectable item on the screen of FIG. 5. The user can select any of the “image synthesis modes”.

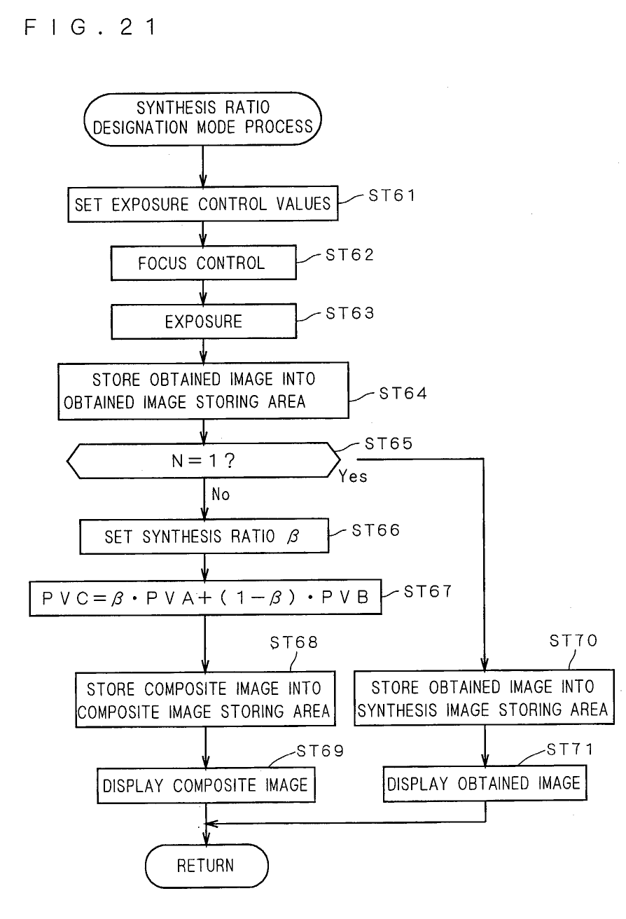

The outline of operations in the image capturing mode of the digital camera 1 when the setting of activating the image synthesis function is made is similar to that shown in FIG. 7 except for operations in step ST5 and the like. Concretely, as shown in FIG. 20, a setting of the “image synthesis mode” is checked in step ST5. When the “image synthesis mode” is “synthesis ratio designation mode”, a synthesis ratio designation mode process (step ST13) is performed. When “image synthesis mode” is “addition synthesis mode” or “averaging synthesis mode”, a process similar to that in the first preferred embodiment is performed.

In “synthesis ratio designation mode”, as will be described, each time an image to be synthesized is obtained, designation of a synthesis ratio is received, so that “continuous photographing” operation is impossible. Consequently, “single photographing” is forcedly set as the “drive mode”. Therefore, when the synthesis ratio designation mode process is performed, the process advances to step ST9 in FIG. 7 and waits for an operation of either re-depression of the shutter start button 11 or end instruction.

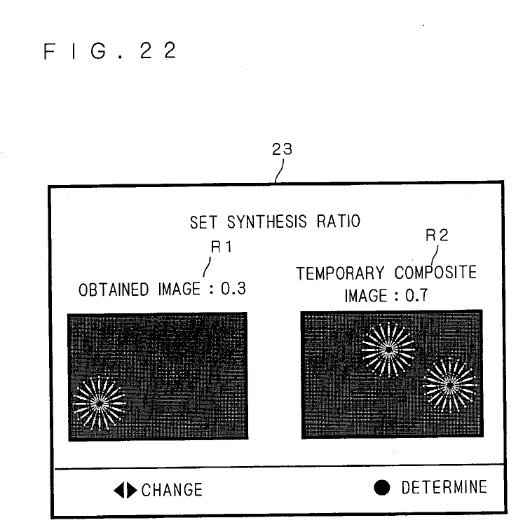

FIG. 21 is a diagram showing the detailed flow of the synthesis ratio designation mode process (step ST13 in FIG. 20).

First, exposure control values (f-number and shutter speed) are determined by the exposure control part 45 on the basis of a photometric value inputted from the photometric computing part 206 and “exposure mode”, and predetermined signals are transmitted to the lens driving part 211 and the timing generator 210 so that the determined exposure control values are set. At this time, a program chart similar to that in “addition synthesis mode” (FIG. 10) is referred to (step ST61).

After the exposure control values are determined by the exposure control part 45, a focus control is performed by the AF control part 46 to make a subject image enter an infocus state (step ST62) and the CCD 201 is exposed to light for set exposure time (step ST63).

The image obtained by the CCD 201 is subjected to predetermined processes by the signal processing circuit 202, A/D converter 203, image processing part 204, and resolution converting part 205 and the processed image is stored in the obtained image storing area 61 in the image memory 60 (step ST64).

Subsequently, whether the obtained image is the first image to be synthesized or not is determined by the image synthesizing part 48 (step ST65). If the obtained image is the first image, the obtained image is stored as it is in the composite image storing area 62 in the image memory 60 (step ST70) and displayed on the LCD 23 for predetermined time (step ST71).

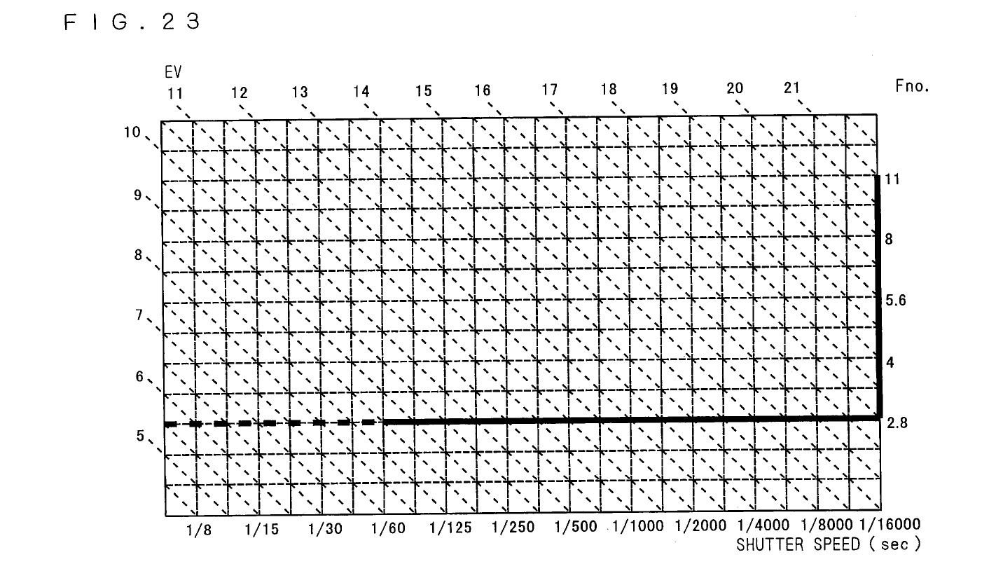

On the other hand, when the obtained image is not the first image, a screen for receiving a synthesis ratio β of the obtained image is displayed on the LCD 23 under control of the image synthesizing part 48. FIG. 22 is a diagram showing an example of the screen for receiving the synthesis ratio β. As shown in the diagram, both the obtained image and a temporary composite image are displayed on the LCD 23 and synthesis ratios R1 and R2 of the images are displayed on the upper side of the images. The synthesis ratios R1 and R2 have the relation of R1+R2=1. By operating the right and left switches 19R and 19L of the cross key 19, both of the values can be changed. Specifically, each time the left switch 19L is depressed, the synthesis ratio R1 of the obtained image increases by 0.1 and the synthesis ratio R2 of the temporary composite image decreases by 0.1. On the contrary, each time the right switch 19R is depressed, the synthesis ratio R2 increases by 0.1 and the synthesis ratio R1 decreases by 0.1. Each of the synthesis ratios R1 and R2 can be set within the range from 0.0 to 1.0. In the case where the synthesis ratio R1 is set to 0.0, a setting that the obtained image is not synthesized is made. In the case where the synthesis ratio R1 is set to 1.0, a setting of synthesizing only the obtained image to obtain a new temporary composite image is made.

When the execution button 19C is depressed in the screen of FIG. 22, the value of R1 at the time point is determined as the synthesis ratio β of the obtained image (step ST66). The obtained image stored in the obtained image storing area 61 and the temporary composite image stored in the composite image storing area 62 are read out and the following Equation 5 is executed on each of corresponding pixels in the two images, thereby generating a composite image.

PVC=β·PVA+(1−β)·PVB Equation 5

That is, an image obtained by multiplying the obtained image with the synthesis ratio β and an image obtained by multiplying the temporary composite image with (1−β) are added to each other, thereby generating a composite image (step ST67).

The generated composite image is stored as a temporary composite image in the next synthesizing process into the composite image storing area 62 (step ST68) and is displayed on the LCD 23 for predetermined time (step ST69).

When the shutter start button is depressed again (Yes in step ST9 in FIG. 7), the series of processes of acquisition of a new image to be synthesized, setting of the synthesis ratio β, computation of Equation 5, and the like is repeated. By repeating such processes, finally, a composite image to be obtained is stored into the composite image storing area 62.

The composite image is generated on the basis of the synthesis ratio β which is set for each of the plurality of images to be synthesized. Consequently, by setting the synthesis ratio of an arbitrary image to a relatively high ratio, for example, a composite image in which a desired subject image is emphasized can be generated.

6. Modifications

Although the preferred embodiments of the present invention have been described above, the present invention is not limited to the foregoing preferred embodiments but can be variously modified.

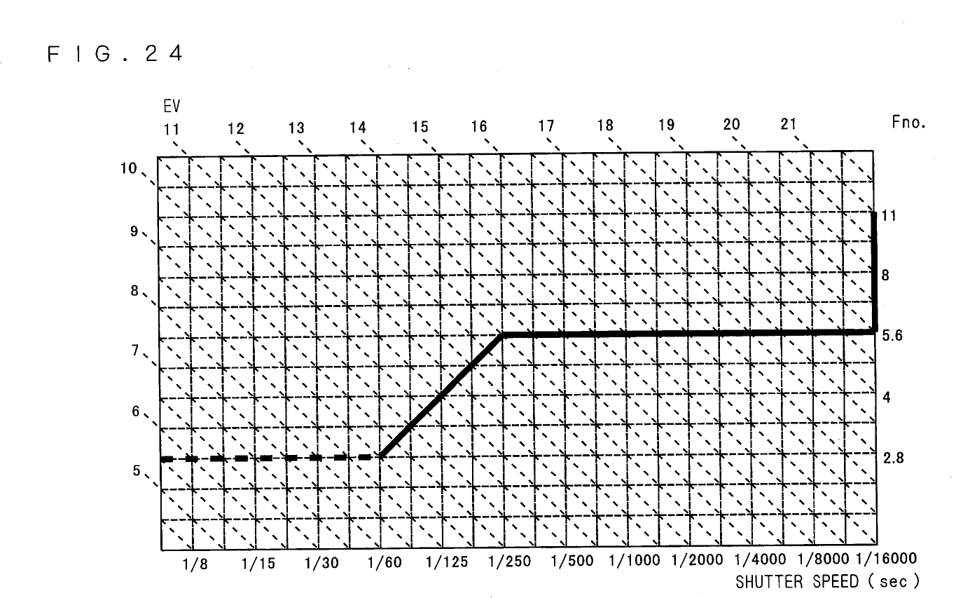

For example, various program charts which are referred to in accordance with the settings of not only “image synthesis modes” but also “drive mode” and the like may be used. FIGS. 23 and 24 show examples of program charts which are referred to when “image synthesis mode” is “averaging synthesis mode”, “drive mode” is “continuous photographing”, and “exposure mode” is “P mode”. In the case of using the program chart shown in FIG. 23, in a range in which the exposure control can be performed only by an f-number, the shutter speed is set to the highest speed (1/16000 second) in the digital camera 1. It can suppress a movement of a subject image and improve continuous photographing speed. However, even in the case of a subject of relatively high luminance, the f-number is set to the open aperture, so that the risk of occurrence of noise called a smear in an image increases. In other words, a request for “higher shutter speed” and a request for “smaller aperture size” compete with each other. Consequently, a program chart for achieving a compromise between the two requests as shown in FIG. 24 may be used.

In the fourth preferred embodiment, both whether the image synthesizing function is activated or not and “image synthesis mode” are set in accordance with a scene selected in the “scene selector” function. Whether the image synthesizing function is activated or not may be set by the user and only “image synthesis mode” may be selected according to a scene selected in the “scene selector” function. For example, in “portrait”, “scenery”, and “sports” in which a subject is generally relatively bright, “averaging synthesis mode” is selected. In “night view” in which a subject is relatively dark, “addition synthesis mode” is selected.

It is also possible to select “image synthesis mode” in accordance with luminance (brightness) of the subject. Specifically, a photometric value obtained by the photometric computing part 206 is determined and, when the photometric value is equal to or larger than a predetermined reference value, “averaging synthesis mode” is selected. When the photometric value is less than the predetermined reference value, “addition synthesis mode” is selected.

The “synthesis ratio designation mode” described in the fifth preferred embodiment may be provided as one of “image synthesis modes” for the digital camera 1 in each of the second to fourth preferred embodiments. For example, in the digital camera 1 of the third preferred embodiment, when “single photographing” is set as “drive mode”, “synthesis ratio designation mode” may be selected.

In the synthesis ratio designation mode process, the synthesis ratio β is set each time an image to be synthesized is obtained. It is also possible to designate the synthesis ratios for all of a plurality of images to be synthesized in a lump before an image capturing instruction is given. That is, the expected number of a plurality of images to be synthesized and the synthesis ratios for the images can be preset. In this case, even when “continuous photographing” is set as “drive mode”, a composite image can be generated by a synthesizing method which is set in the synthesis ratio designation mode.

In the foregoing preferred embodiments, it has been described that when the CPU executes a computing process in accordance with a program, various functions are realized. All or a part of the functions may be realized by a dedicated electric circuit. Particularly, by constructing a part of repeating computation by a logic circuit, high-speed computation is realized. On the contrary, all or a part of the functions realized by the electric circuit may be realized by performing a computing process by the CPU in accordance with a program.

While the invention has been shown and described in detail, the foregoing description is in all aspects illustrative and not restrictive. It is therefore understood that numerous modifications and variations can be devised without departing from the scope of the invention.

What is claimed is:

1. A digital camera having an image capturing device for obtaining an image of a subject, comprising:
a synthesis mode selector for selecting one image synthesis mode from a plurality of image synthesis modes in which different synthesizing methods each for synthesizing a plurality of images are set;
an instruction reception part for receiving an image capturing instruction for allowing said image capturing device to start capturing images, from a user; and
a synthesizing part for generating a composite image by synthesizing a plurality of images obtained by said image capturing device by using one of the different synthesizing methods in said image synthesis modes selected, in response to said image capturing instruction.

2. The digital camera according to claim 1, wherein
said plurality of image synthesis modes include an addition synthesis mode of generating said composite image by adding respective pixel values of pixels which are respectively included in said plurality of images and correspond to one another.

3. The digital camera according to claim 1, wherein
said plurality of image synthesis modes include an averaging synthesis mode of generating said composite image by averaging respective pixel values of pixels which are respectively included in said plurality of images and correspond to one another.

4. The digital camera according to claim 3, further comprising:
an exposure controller for setting exposure time in which said image capturing device obtains each of said plurality of images in said averaging synthesis mode to predetermined reference time or shorter.

5. The digital camera according to claim 1, further comprising:
a setting reception part for receiving an image capturing control setting regarding capture of an image, from the user, wherein
said synthesis mode selector selects an image synthesis mode from said plurality of image synthesis modes on the basis of said image capturing control setting.

6. The digital camera according to claim 1, further comprising:
a synthesis ratio reception part for receiving a setting of a synthesis ratio of each of said plurality of images, from the user, wherein
said plurality of image synthesis modes include a synthesis ratio designating mode of generating said composite image on the basis of a synthesis ratio set for each of said plurality of images.

7. The digital camera according to claim 4, further comprising:
an adjusting part for adjusting brightness of said image to be synthesized which is obtained by said image capturing device so as to correct underexposure which occurs in said image to be synthesized.

8. The digital camera according to claim 5, wherein
said setting reception part includes a scene selector for allowing one scene capturing control to be selected from a plurality of scene capturing controls for respective scenes of a subject, and
said synthesis mode selector selects one image synthesis mode from said plurality of image synthesis modes on the basis of said selected scene capturing control.

9. The digital camera according to claim 5, wherein
said setting reception part includes an operation mode selector for allowing an operation mode of said image capturing device to be selected between a single photographing operation of obtaining one image in response to one image capturing instruction and a continuous photographing operation of obtaining a plurality of images sequential in time in response to a single image capturing instruction, and
said synthesis mode selector selects one image synthesis mode from said plurality of image synthesis modes on the basis of said selected operation mode.

10. The digital camera according to claim 5, wherein
said setting reception part includes an exposure mode selector for allowing an exposure mode to be selected between an automatic determination mode in which said digital camera determines at least one of an f-number and exposure time and a manual determination mode in which the user determines both of said f-number and said exposure time, and
said synthesis mode selector selects one image synthesis mode from said plurality of image synthesis modes on the basis of said selected exposure mode.

11. A digital camera having an image capturing device for capturing an image of a subject, comprising:
an instruction reception part for receiving an image capturing instruction for allowing said image capturing device to start capturing image, from a user;
a setting part for setting an addition ratio used in synthesizing said plurality of images; and
a synthesizing part for generating a composite image by synthesizing a plurality of images obtained by said image capturing device by addition on the basis of the addition ratio set by said setting part.

12. The digital camera according to claim 11, further comprising:
a synthesis ratio reception part for receiving a setting of a synthesis ratio for each of said plurality of images, from the user, wherein
said setting part sets said addition ratio on the basis of said synthesis ratio received by said synthesis ratio reception part.

13. The digital camera according to claim 11, further comprising:
a synthesis mode selector for selecting one image synthesis mode from a plurality of image synthesis modes in which different synthesis modes each for synthesizing a plurality of images are set, wherein
said plurality of image synthesis modes includes a mode of synthesizing said plurality of images by addition.
